(19) United States
(12) Patent Application Publication
(10) Pub. No.: US 2021/0071947 A1
(43) Pub. Date: Mar. 11, 2021

(54) METHOD AND APPARATUS FOR AN IMPROVED CARBON MONOXIDE COLD BOX OPERATION

(71) Applicants: Joseph M Schwartz, Williamsville, NY (US); Luke J Coleman, Williamsville, NY (US); Minish Mahendra Shah, East Amherst, NY (US); David R Barnes, Keene, NH (US)

(72) Inventors: Joseph M Schwartz, Williamsville, NY (US); Luke J Coleman, Williamsville, NY (US); Minish Mahendra Shah, East Amherst, NY (US); David R Barnes, Keene, NH (US)

(21) Appl. No.: 16/563,065

(22) Filed: Sep. 6, 2019

(51) Int. Cl. F25J 3/02; C01B 3/24

(52) U.S. Cl. CPC F25J 3/0223; F25J 3/0209; C01B 3/24; F25J 2245/02; F25J 2210/04; F25J 2210/18; F25J 2205/40

(57) ABSTRACT

The present invention is directed to a method and system of separating carbon monoxide from syngas mixtures with low methane content by cryogenic means where a partial condensation cycle is generally employed, and more specifically towards providing a methane slip stream to the feed in order to reduce the potential for any carbon dioxide entering the cold box to freeze, thereby preventing plugging of the cold box heat exchanger.

### BACKGROUND OF THE INVENTION

### Field of the Invention

The present invention relates to a method of separating carbon monoxide from a synthesis gas containing hydrogen, carbon monoxide, methane, water, and carbon dioxide. More specifically, the invention is directed to a method of separating carbon monoxide from syngas mixtures with low methane content by cryogenic means where a partial condensation cycle is generally employed, and more specifically towards increasing the methane concentration in the feed to make it less likely that carbon dioxide freezes and plugs the heat exchanger.

### Description of Related Art

Hydrocarbons such as natural gas, naphtha, and liquefied petroleum gas (LPG) can be reacted with oxygen and/or steam to obtain a synthesis gas (i.e., a mixture of hydrogen (H₂), carbon monoxide (CO), methane (CH₄), water (H₂O), and carbon dioxide (CO₂) commonly referred to as “syngas”). The reformer processes including reformation in a partial oxidation reformer, autothermal reformer or a steam methane reformer are well known, and they are typically utilized to obtain syngas which is ultimately utilized in the production of hydrogen, carbon monoxide, or chemicals such as methanol and ammonia. Conventional techniques for the separation of CO from the rest of the syngas constituents have been known. For instance, cryogenic purification methods employing what is commonly referred to as a cold box, such as partial condensation or scrubbing with liquid methane, are well known techniques.

The syngas typically contains a significant amount of CO₂ and H₂O that must be removed upstream of cryogenic purification, typically by condensing the water and removing the liquid, removing most of the carbon dioxide by amine absorption, and removing the remaining CO₂ and water in a temperature swing adsorption (TSA) unit, commonly referred to as a dryer. CO₂ and water must be removed to very low levels, typically less than 50 ppb, to prevent freezing in the cold box heat exchanger.

Occasionally, the TSA dryer does not function properly, and a low level of CO₂ or water will break through. In most cases, water is more strongly adsorbed, so CO₂ typically breaks through first. When this occurs, CO₂ can solidify inside the process heat exchanger in the cold box. The passages in the heat exchanger are typically narrow to provide good heat transfer. Therefore, any amount of solidification inside a passage can cause the heat exchanger to plug, leading to a plant shutdown.

In the related art for CO production, U.S. Pat. No. 3,886,756 to Allam et al. proposes a reversible heat exchanger to deposit carbon dioxide and water vapor in solid form on its inner surface. In this process, after solid CO₂ or water is deposited on the heat exchanger wall, a hydrogen-rich stream is fed countercurrently through the contaminated passages to warm and evaporate the deposited solids. This process requires expensive, complex heat exchangers and switching and isolation valves, making the related art process difficult to operate.

U.S. Pat. No. 5,632,162 to Billy proposes an additional adsorption vessel downstream of the dryer to capture any water or carbon dioxide that breaks through. The main purpose of the bed as described in the patent is to desorb CO when a fresh dryer bed is brought online and to adsorb CO when the dryer bed is saturated with CO. The main advantage of the process stated in this document is that it reduces the variation in the cold box feed stream composition by supplying CO when the CO content exiting the dryer is lower and by removing CO when the CO content exiting the dryer is higher. Another possible advantage is that it could reduce a temperature spike that can occur when switching to a new bed, providing a more consistent feed temperature to the cold box. The additional vessel increases the capital cost of the system and adds operational complexity.

U.S. Pat. No. 6,578,377 to Licht et al. proposes the use of a separator to remove liquid formed at relatively high temperatures compared to the standard CO cold box process. This separator is designed to remove hydrocarbons heavier than methane that could freeze at the lower temperatures experienced by the syngas stream in the cold box. While this document proposes a method to avoid freezing in the cold box caused by contaminants in the feed, it adds a separator and is not applicable to carbon dioxide and water.

U.S. Pat. No. 8,966,937 to Haik-Beraud et al. proposes recycling a methane-enriched stream exiting the cold box and furthermore proposes mixing the recycled methane with the cold box feed downstream of the syngas generator. Haik-Beraud et al. proposes recycling the methane stream specifically to a cryogenic distillation plant comprising at least one column for scrubbing with methane, such as a standard methane wash process common in the prior art. A standard methane wash process requires that the syngas feed contains at least an amount of methane sufficient for supporting the methane wash column, about 2.0-2.5%. Haik-Beraud et al. specifies that it applies to scenarios in which the syngas feed contains less than 2.3% methane and that sufficient methane is recycled to increase the methane content of the cold box stream to at least 2.3% methane. While Haik-Beraud et al. describes a process in which methane is recycled to the cold box feed, the process requires a methane wash column. Furthermore, the reason discussed for recycling the methane is because of the methane wash column, which does not exist in the partial condensation process of the present invention. The methane wash process and the partial condensation process are two fundamentally different CO purification processes.

To overcome the disadvantages of the related art, it is an object of the present invention to provide an improved process and apparatus to overcome upsets in the TSA dryer and avoid freezing of CO₂ inside the cold box.

It is another object of the invention to reduce the downtime of the cold box and increase the time duration of uninterrupted operation by reducing the number of shutdowns. Should the process heat exchanger inside the cold box plug due to frozen CO₂ or water, the cold box must shut down and be thawed. This entire cycle can take several days before the plant can restart, resulting in several days of lost production and revenue.

It is a further objective of the invention to provide a simplified apparatus and process that is more reliable and easier to operate than those of the related art. The proposed invention uses conventional multi-stream heat exchangers that do not require reversing the flow direction of any stream.

Other objects and aspects of the present invention will become apparent to one of ordinary skill in the art upon review of the specification, drawings and claims appended hereto.

### SUMMARY OF THE INVENTION

According to an aspect of the invention, a method for reducing carbon dioxide freezing in a partial condensation carbon monoxide cold box that separates a combined syngas feed is provided. The method includes:

cooling and partially condensing the combined cold box syngas feed stream (2) in a process heat exchanger (101) to produce a cooled and partially condensed syngas feed stream (5);

separating the cooled and partially condensed syngas feed stream (5) into a hydrogen rich vapor stream (8) and a carbon monoxide rich liquid stream (10) in a single-stage high-pressure separator (102);

routing the carbon monoxide rich liquid stream (10) to a downstream separation train to separate and form at least a CO-rich stream, a methane-rich liquid stream, and a flash gas vapor stream;

wherein a methane-rich stream is added to the syngas feed upstream of a CO₂ freeze zone (140) in the process heat exchanger (101) to increase the concentration of methane in the mixture thereby reducing carbon dioxide freezing in the partial condensation carbon monoxide cold box.

### BRIEF DESCRIPTION OF THE FIGURES

The objects and advantages of the invention will be better understood from the following detailed description of the preferred embodiments thereof in connection with the accompanying figures wherein like numbers denote same features throughout and wherein:

FIG. 1 is a process flow diagram depicting the mixing of the syngas feed with a methane-containing stream upstream of the freeze zone in the process heat exchanger and the cryogenic purification train that produces separated streams;

FIG. 2 is a process flow diagram of a partial condensation cold box cycle in accordance with one exemplary embodiment of the invention where the methane-rich gas is recycled to the cold box feed end;

FIG. 3 is a process flow diagram illustrating another embodiment of the present invention where a liquid methane stream is recycled and mixed with the syngas feed at an intermediate location of the process heat exchanger; and

FIG. 4 illustrates another flow diagram of an autothermal reformer plant taking a slip stream from the pre-reformer outlet and introducing it upstream of the amine system prior to the formation of the syngas routed into the cold box.

### DETAILED DESCRIPTION OF THE INVENTION

The present invention provides for the cryogenic separation of carbon monoxide from mixtures containing at least hydrogen, carbon monoxide, and methane, particularly in cases where the methane content in the feed is low (<2%), and which necessitates the use of a partial condensation cycle. There are many types of production processes which may be used to produce a syngas mixture (i.e., the feed syngas) meeting this specification, for example, a partial oxidation or autothermal reforming process. The syngas created in these processes must be cooled and the bulk water and CO₂ must be removed prior to further pretreatment.

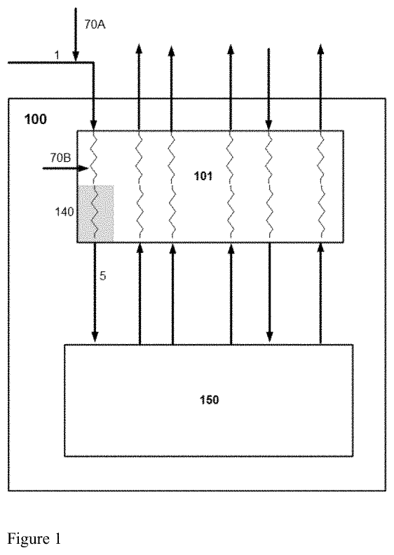

The important aspects of the invention include introducing methane into the syngas feed stream to the cold box so as to dissolve any residual CO₂ in a condensed liquid during the cooling of the syngas feed before CO₂ can solidify/freeze in the cold box. With reference to FIG. 1, a syngas feed stream (1) generated by an autothermal reformer, partial oxidation reactor, or other syngas generator (not shown) is treated to remove most of the contained water and carbon dioxide (not shown). The syngas feed stream (1) at near ambient temperature and elevated pressure, typically ranging from about 250 to about 500 psig, is received from a treatment unit (not shown) that removes the majority of the water and carbon dioxide. The syngas feed is fed to a partial condensation cold box (100) that contains a process heat exchanger (101). The process heat exchanger is designed to reduce the temperature of the syngas feed to cryogenic temperatures, below 100° K, and condense a portion of the feed, producing a partially condensed syngas feed stream (5). If the syngas feed contains too much CO₂, typically above about 50 ppb by volume, it is possible that CO₂ could freeze in the process heat exchanger. The location where CO₂ would freeze is referred to herein as “the freeze zone” (140). The exact location of the freeze zone depends on the CO₂ concentration and the operating conditions. The syngas feed (1) is mixed with a methane-containing stream (70A) and/or (70B) to increase the methane content of the combined feed before the syngas feed enters the freeze zone (140) of the process heat exchanger (101), thus preventing CO₂ present in the feed due to an upset in the upstream dryer, from freezing. The partially condensed syngas feed stream (5) is fed to a cryogenic purification train (150) that separates the feed into at least a hydrogen-rich stream, a CO-rich stream, and a methane-rich stream. These separated streams are fed to the process heat exchanger where they cool the syngas feed.

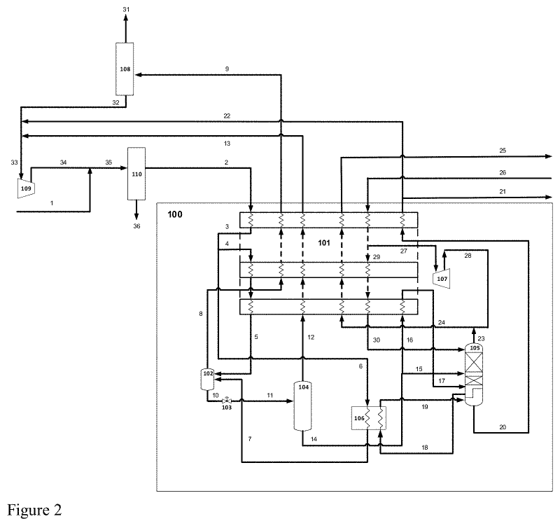

Turning to FIG. 2, the unpurified syngas feed stream (1) is combined with a recycle stream (34) described below, and the combined stream (35) is routed to a dryer device (110) to remove substantially all of the water and carbon dioxide (36) and produce a cold box feed stream (2) containing methane in a range of about 0.3 to about 4 volume percent. Depending on the content of methane in this cold box feed stream (2), the dew point temperature for this stream can range from about 103° K to about 113° K. For all intents and purposes H₂O and CO₂ are removed from the syngas stream to levels below the detection limit of most conventional analyzers. Practically speaking, H₂O is typically removed to below 10 ppb, preferably less than 1 ppb, and CO₂ is typically removed to below 100 ppb, preferably less than 25 ppb. Even at these concentrations of CO₂ slip, CO₂ can freeze out in a partial condensation cold box leading to plugging of the process heat exchanger. The higher the CO₂ slip from the dryer, the shorter the time duration it takes to completely block the heat exchanger passages. Further, process disturbances can result in higher, transient concentrations of CO₂ being introduced to the cold box. A methane recycle stream (22), a flash gas stream (13), and a tail gas stream (32), all of which are discussed in detail below, are mixed to form a low-pressure recycle mixture stream (33) which is compressed in a compressor (109) and routed to a dryer (110) in the process of removing the residual water and carbon dioxide from syngas feed stream (1). The dryer (110) is typically regenerated using a dry gas stream that does not contain carbon dioxide (not shown).

Cold box feed stream (2) is routed to a process heat exchanger (101) disposed within a cryogenic process unit, a cold box (100) and exits the process heat exchanger (101) as a cooled cold box feed stream (3), typically at a temperature ranging from 130 to 140° K. The cooled cold box feed stream (3) is split into a partial condensation feed stream (4) and reboiler feed stream (6). The partial condensation feed stream (4) is cooled further in the process heat exchanger (101) to a temperature typically ranging from about 85 to about 95° K, and exits the heat exchanger as a partially condensed feed stream (5), which is routed to a high-pressure separator (102), operating at pressures ranging from about 250-450 psig. This is the region of the process heat exchanger where any carbon dioxide present in the feed would freeze and provides the aforementioned freeze zone.

The reboiler feed stream (6) is cooled to a temperature ranging from about 90 to 100° K in a reboiler (106) while providing heat to a reboiler liquid stream (18) and exits the reboiler as a partially condensed reboiler feed stream (7) (at a temperature ranging from about 85-100° K), which is also fed to the high-pressure separator (102). The partially condensed feed stream (5) and partially condensed reboiler feed stream (7) are separated in the high-pressure separator (102) to produce a high-pressure crude liquid carbon monoxide stream (10) and a crude hydrogen vapor stream (8), which is warmed in the process heat exchanger (101) to produce a warmed crude hydrogen stream (9) that is subsequently fed to a pressure swing adsorption system (108) to separate hydrogen product (31) and tail gas (32).

The high-pressure crude liquid carbon monoxide stream (10) is expanded across a valve (103) to produce a low-pressure crude liquid carbon monoxide feed (11) that is fed to a low-pressure separator (104), typically operating between 20 and 40 psig. The low-pressure separator (104) can be a single-stage separator vessel as shown in FIG. 2 or a dual-stage separator, a multi-stage distillation or stripping column, or other means to remove most of the hydrogen contained in the low-pressure separator feed stream (11). A dual-stage separator or a stripping column will require an associated reboiler which can be heated by the partially condensed reboiler stream or by a separate second reboiler feed stream. Selection of the device employed for the low-pressure separator (104) depends on the hydrogen purity requirement of the carbon monoxide product. The low-pressure separator (104) produces a cold flash gas vapor stream (12) consisting primarily of hydrogen (in a range from about 40-60%) and carbon monoxide (in a range from about 40-60%) with small amounts of methane, nitrogen and argon recovered from an upper portion of the low-pressure separator (104) and a crude carbon monoxide liquid stream (14) consisting primarily of carbon monoxide with a few percent methane and nitrogen recovered from a lower section of the low-pressure separator (104). The cold flash gas vapor stream (12) is directed into the process heat exchanger (101) where it is warmed to produce a flash gas stream (13), which is typically near ambient temperature. The crude carbon monoxide liquid stream (14) is divided into a direct column feed stream (15) and a liquid split feed (16). The direct column feed (15) is fed directly to a distillation column (105) while the liquid split feed (16) is at least partially vaporized in the process heat exchanger (101) to form an at least partially vaporized column feed stream (17), which is fed to the distillation column (105) at a location below the direct column feed (15) location.

Distillation column (105) typically operates at pressures ranging from about 5 to about 30 psig, preferably between 10 and 20 psig and separates the streams fed into it to produce a cold carbon monoxide product stream (23) at the upper portion of column (105) and a methane-rich liquid stream (20), which is removed from the lower portion of said column (105). The concentration of methane in the methane-rich liquid stream (20) could range anywhere from 50 to 98% (by volume), preferably between 85 and 95% (by volume). Concurrently, a reboiler liquid stream (18) is removed from a lower portion of the distillation column (105) and routed to reboiler (106) where it is heated to produce a partially boiled bottoms stream (19) that is returned to the sump of the distillation column (105). The methane-rich liquid stream (20) removed from the bottom portion of distillation column (105) is routed to the process heat exchanger (101) where it is vaporized and heated to produce a methane rich gas stream that is split into a fuel gas stream (21) and a methane recycle stream (22). The amount of methane recycle stream will depend on the methane concentration in the syngas feed stream (1). The methane recycle in the partial condensation process improves the reliability of the cold box by making it more resistant to freezing and plugging of the process heat exchanger (101), as discussed in detail below.

The cold carbon monoxide product stream (23) is mixed with a turbine exhaust stream (28) to form a combined cold carbon monoxide product (24), which is heated in the process heat exchanger (101) to produce a warm carbon monoxide product stream (25), which is compressed in a carbon monoxide compressor (not shown). A portion of the compressed carbon monoxide product stream is recovered as product. The remainder of the compressed warm carbon monoxide product is recycled to the cold box as a carbon monoxide recycle stream (26), typically ranging from about 100 to 200 psig. The carbon monoxide recycle (26) can be at the same pressure as the recovered product or at a different pressure if it is compressed in a different number of stages in the carbon monoxide compressor.

The carbon monoxide recycle stream (26) is cooled in the process heat exchanger (101) and split into a turbine feed stream (27) and a warm carbon monoxide reflux stream (29). The turbine feed (27), which is typically at a similar temperature to the cooled cold box feed (3) of about 130 to 140° K, is expanded in a turbine (107) to produce the turbine exhaust stream (28), which is at lower pressure, typically at or slightly above the distillation column pressure of 5 to 30 psig, and lower temperature than the turbine feed (27), typically close to its dew point or possibly containing some liquid. The warm carbon monoxide reflux stream (29) is cooled further in the process heat exchanger (101) to produce a cold carbon monoxide reflux liquid stream (30), which is fed to the distillation column (105) as a reflux stream.

As referenced above, the pressure swing adsorption system (108) produces a high-purity hydrogen product stream (31) and a low-pressure tail gas stream (32) that contains in a range of about 40 to 60% hydrogen and in a range of about 40 to 60% carbon monoxide and a few percent methane, nitrogen and argon. The tail gas stream (32), the flash gas stream (13), and the methane recycle stream (22) are combined to produce a low-pressure recycle mixture stream (33) that typically contains about 5-15% methane. The low-pressure recycle mixture (33) is compressed in a recycle gas compressor (109) to produce the high-pressure recycle stream (34) that is combined with the syngas feed stream (1) to produce the dryer feed (35), which is fed to the dryer (110).

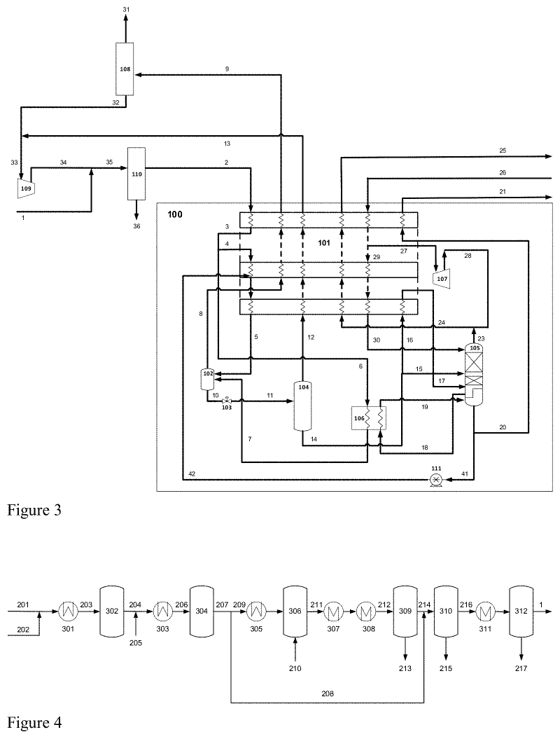

With reference to FIG. 3, an alternative exemplary embodiment is depicted where all streams are essentially the same as in FIG. 2, except that the methane recycle stream (22) is removed. Instead of recycling methane gas stream (22) to the cold box feed, the process shown in FIG. 3 recycles methane as a liquid and feeds it directly to the heat exchanger in the most vital area to prevent freezing. A methane-rich liquid recycle (41) is split from the methane-rich liquid stream (20) exiting the bottom of the distillation column (105) and pressurized in a liquid methane pump (111) to form a high-pressure methane-containing liquid stream (42). The high-pressure methane-containing liquid (42) is combined with the partial condensation feed (4) in the process heat exchanger (101) upstream of the freeze zone so that the liquid methane will dissolve any carbon dioxide in the partial condensation feed (4) before the carbon dioxide can freeze and plug the process heat exchanger (101). The CO₂ freezing zone is the area of the heat exchanger in which CO₂ present in the feed would freeze, typically between 105 to 115° K, thus high-pressure methane-containing liquid (42) is combined with the partial condensation feed (4) at a location where stream (4) temperature is above about 115° K, preferably in the range of about 115 to 125° K. The location shown in FIG. 3 is approximate and would depend on the design of the particular heat exchanger, but it must be upstream of the freeze zone. The freeze zone is between the locale of stream (4) entering the process heat exchanger and the locale of stream (5) exiting the process heat exchanger.

The embodiment of FIG. 3 also provides liquid to the process heat exchanger (101) and it can provide some liquid slightly above the dew point if it is injected at the proper location. This could enable carbon dioxide dissolution at a higher temperature than the recycled gas as shown in FIG. 2, providing additional freeze protection.

In another embodiment, a methane-rich stream is mixed with a syngas stream well upstream of the cold box by taking a portion of the treated natural gas that feeds the syngas generator, bypassing the syngas generator, and blending with the produced syngas stream upstream of the CO₂ removal unit. With reference to FIG. 4, this embodiment is described in the context of an authothermal reformer plant.

In this embodiment, a portion of the prereformer outlet stream is split, bypasses the reformer, and is mixed with the syngas feed upstream of the CO₂ removal unit to remove any carbon dioxide contained in the combined syngas stream. The advantage of using a pre-reformer outlet stream instead of a hydrocarbon feed is that sulfur has been largely removed and higher hydrocarbons, which may freeze in the cold box, have also been largely eliminated. The methane-rich bypass method has the advantage of rapid response time and does not require cycling time to build inventory as does the methane recycle method.

As depicted in FIG. 4, in this embodiment, a carbon-containing feed stream (201), such as natural gas, LPG, or other hydrocarbon, and a hydrogen feed stream (202) are mixed and heated in a hydrodesulfurizer (HDS) preheater (301) to form an HDS feed (203). The HDS feed (203) is routed to a hydrodesulfurizer (302), where sulfur compounds are converted to H₂S and removed. A desulfurized feed stream (204) exiting hydrodesulfurizer (302) is mixed with steam (205) and heated further in a prereformer heater (303) to produce a prereformer feed stream (206). The prereformer feed stream (206) is fed to a prereformer (304) where higher hydrocarbons and olefins in the prereformer feed are converted to methane, forming a prereformer product stream (207). A portion of the prereformer product (207) can be used as a methane-rich bypass stream (208) while the remaining prereformer product stream (209) is heated further in a reformer heater (305) and reacted with an oxidant stream (210), such as oxygen, air, steam, or a mixture thereof in a reformer (306), such as an autothermal reformer, to produce a reformer syngas product stream (211). The reformer syngas product (211) is cooled in a boiler (307) and a syngas cooler (308) to produce a partially condensed reformer syngas product (212), which is fed to a separator (309), from which liquid water (213) is removed. The cooled reformer syngas product (214) is mixed with the methane-rich bypass stream (208) and sent to a CO₂ removal system (310), such as an amine system, to remove carbon dioxide, and other impurities (215), producing a CO₂-depleted syngas (216). The CO₂-depleted syngas (216) is cooled in a syngas dryer feed cooler (311) and fed to a second separator (312), which removes a second separator water stream (217), producing the syngas feed (1), which now does not require additional methane.

Alternatively, the invention can be modified to increase the amount of methane in the cold box feed by increasing the methane in the reformer syngas product. This can be carried out by changing the syngas generator operating conditions to reduce the extent of methane conversion by reducing the temperature, changing the operating pressure, or reducing the feed of the other reactants, such as oxygen, to the syngas generator. It is anticipated that such changes would affect the composition beyond just the methane component.

Alternatively, methane addition would be used only when necessary to obtain the full benefit while also minimizing power consumption. If methane addition is used only part of the time, it would be used when CO₂ breakthrough from the dryer unit (110) is most likely, such as the time near the end of the adsorption cycle in the dryer bed or after a process disturbance. In an exemplary embodiment, CO₂ can be measured in the cold box feed and the invention used when it begins to increase. However, measuring such low concentrations as are expected in the dryer effluent accurately can be difficult and there might not be enough time to realize the benefits of methane recycle before too much CO₂ entered the cold box. It is likely that the methane-rich bypass technique would be strongly preferred in this scenario over a methane recycle technique.

The embodiment described in FIG. 4 could be applied to a syngas generator comprising a steam methane reformer followed by a secondary reformer where oxygen is added to the secondary reformer to produce additional syngas. In such a process, a bypass stream can be taken at the outlet of the steam methane reformer and combined with the syngas feed upstream of the CO₂ removal unit.

In another exemplary embodiment, the CO₂ entering the dryer would be measured and methane added when the dryer inlet has more CO₂ than expected. Although this is less direct, it could also correspond to times when more CO₂ would escape the dryer and would respond faster than waiting to see increased CO₂ exiting the dryer.

A further embodiment would be to implement methane addition when the adsorbent reached a certain age because older adsorbent has less capacity and is less reliable than fresh adsorbent. In this case, methane addition or recycle could be used to extend the useful life of the bed, delay a shutdown, and increase total production from the plant by changing the bed when there was a planned shutdown or a shutdown due to another reason.

A further method would be to implement methane addition at the end of a bed cycle. This would be more challenging because of the time required to build methane inventory in the system and one might prefer to change the bed cycle time to prevent breakthrough instead of implementing temporary methane addition. This might be a particularly good time for implementing the methane bypass of the syngas generator to reduce response time.

The following comparative examples provide the advantages of the present invention.

### Comparative Example

The process configured and explained with reference FIG. 2 was designed and operated to recycle sufficient methane in the methane recycle stream (22) to produce a cold box feed (2) containing 2.0% methane. The results of this process were simulated and compared to a conventional process case without methane recycle. The results are provided in Table 1, below for both cases. In each case, the feed to the process is the same and the amount of CO product exiting the process is the same. The feed stream described in Table 1 is the cooled syngas stream leaving the syngas generator, before entering the CO₂ and water removal systems. The product is the CO product produced by the overall process. All other streams in Table 1 are as labeled in FIG. 2.

| Stream | Feed | 2 | 9 | 13 | 21 | 22 |
|---|---|---|---|---|---|---|
| | No Recycle | | | | | |
| Temperature [K] | 376.5 | 284.3 | 283.9 | 283.9 | 283.9 | N/A |
| Pressure [psia] | 409.0 | 380.7 | 374.0 | 40.1 | 19.7 | N/A |
| Molar Flow [lbmole/hr] | 12408 | 12066 | 8864 | 354 | 54 | 0 |
| Mass Flow [lb/hr] | 160875 | 134660 | 50041 | 5589 | 923 | 0 |
| Comp Mole Frac (Hydrogen) | 0.529803 | 0.646585 | 0.860369 | 0.469697 | 0.000000 | 0.000000 |
| Comp Mole Frac (CO) | 0.222010 | 0.343838 | 0.136842 | 0.519655 | 0.078981 | 0.078981 |
| Comp Mole Frac (Methane) | 0.004027 | 0.004354 | 0.000264 | 0.000695 | 0.920001 | 0.920001 |
| Comp Mole Frac (Nitrogen) | 0.002416 | 0.004421 | 0.002288 | 0.009082 | 0.000293 | 0.000293 |
| Comp Mole Frac (Argon) | 0.000604 | 0.000802 | 0.000237 | 0.000871 | 0.000726 | 0.000726 |
| Comp Mole Frac (H2O) | 0.195832 | 0.000000 | 0.000000 | 0.000000 | 0.000000 | 0.000000 |
| Comp Mole Frac (CO2) | 0.045308 | 0.000000 | 0.000000 | 0.000000 | 0.000000 | 0.000000 |
| Mixed Gas Compressor Power | 5255 kW | | | | | |
| CO Compressor Power | 5670 kW | | | | | |
| Total Compressor Power | 10925 kW | | | | | |
| | With Recycle | | | | | |
| Temperature [N] | 376.5 | 284.2 | 284.1 | 284.1 | 284.1 | 284.1 |
| Pressure [psia] | 409.0 | 380.7 | 374.0 | 40.1 | 19.7 | 19.7 |
| Molar Flow [lbmole/hr] | 12408 | 12196 | 8798 | 350 | 54 | 200 |
| Mass Flow [lb/hr] | 160875 | 136029 | 48100 | 5497 | 922 | 3402 |
| Comp Mole Frac (Hydrogen) | 0.529803 | 0.639615 | 0.866838 | 0.472175 | 0.000000 | 0.000000 |
| Comp Mole Frac (CO) | 0.222010 | 0.335248 | 0.129662 | 0.514862 | 0.079016 | 0.079016 |
| Comp Mole Frac (Methane) | 0.004027 | 0.020049 | 0.001086 | 0.003037 | 0.920000 | 0.920000 |
| Comp Mole Frac (Nitrogen) | 0.002416 | 0.004293 | 0.002191 | 0.009062 | 0.000309 | 0.000309 |
| Comp Mole Frac (Argon) | 0.000604 | 0.000795 | 0.000224 | 0.000865 | 0.000675 | 0.000675 |
| Comp Mole Frac (H2O) | 0.195832 | 0.000000 | 0.000000 | 0.000000 | 0.000000 | 0.000000 |
| Comp Mole Frac (CO2) | 0.045308 | 0.000000 | 0.000000 | 0.000000 | 0.000000 | 0.000000 |

| | |
|---|---|
| Mixed Gas Compressor Power | 5487 kW |
| CO Compressor Power | 5781 kW |
| Total Compressor Power | 11268 kW |

| Stream | 25 | 26 | 32 | 33 | Product |
|---|---|---|---|---|---|
| | No Recycle | | | | |
| Temperature [K] | 283.9 | 310.9 | 313.2 | 309.3 | 310.9 |
| Pressure [psia] | 25.1 | 145.6 | 19.7 | 19.7 | 600.0 |
| MolarFlow [lbmole/hr] | 4444 | 1650 | 2305 | 2659 | 2794 |
| Mass Flow [lb/hr] | 124233 | 46130 | 36810 | 42399 | 78103 |
| Comp Mole Frac (Hydrogen) | 0.003238 | 0.003238 | 0.463173 | 0.464041 | 0.003238 |
| Comp Mole Frac (CO) | 0.983494 | 0.983494 | 0.526198 | 0.525328 | 0.983494 |
| Comp Mole Frac (Methane) | 0.000003 | 0.000003 | 0.001016 | 0.000974 | 0.000003 |
| Comp Mole Frac (Nitrogen) | 0.010675 | 0.010675 | 0.008799 | 0.008836 | 0.010675 |
| Comp Mole Frac (Argon) | 0.002590 | 0.002590 | 0.000814 | 0.000822 | 0.002590 |
| Comp Mole Frac (H2O) | 0.000000 | 0.000000 | 0.000000 | 0.000000 | 0.000000 |
| Comp Mole Frac (CO2) | 0.000000 | 0.000000 | 0.000000 | 0.000000 | 0.000000 |
| Mixed Gas Compressor Power | 5255 kW | | | | |
| CO Compressor Power | 5670 kW | | | | |
| Total Compressor Power | 10925 kW | | | | |
| | With Recycle | | | | |
| Temperature [N] | 284.1 | 310.9 | 313.2 | 307.0 | 310.9 |
| Pressure [psia] | 25.1 | 145.6 | 19.7 | 19.7 | 600.0 |
| Molar Flow [lbmole/hr] | 4569 | 1775 | 2239 | 2789 | 2794 |
| Mass Flow [lb/hr] | 127728 | 49623 | 34869 | 43768 | 78105 |
| Comp Mole Frac (Hydrogen) | 0.003272 | 0.003271 | 0.476853 | 0.442070 | 0.003271 |
| Comp Mole Frac (CO) | 0.983455 | 0.983456 | 0.509483 | 0.479288 | 0.983456 |
| Comp Mole Frac (Methane) | 0.000003 | 0.000003 | 0.004266 | 0.069782 | 0.000003 |
| Comp Mole Frac (Nitrogen) | 0.010676 | 0.010675 | 0.008610 | 0.008072 | 0.010675 |
| Comp Mole Frac (Argon) | 0.002595 | 0.002595 | 0.000787 | 0.000789 | 0.002595 |
| Comp Mole Frac (H2O) | 0.000000 | 0.000000 | 0.000000 | 0.000000 | 0.000000 |
| Comp Mole Frac (CO2) | 0.000000 | 0.000000 | 0.000000 | 0.000000 | 0.000000 |

| | |
|---|---|
| Mixed Gas Compressor Power | 5487 kW |
| CO Compressor Power | 5781 kW |
| Total Compressor Power | 11268 kW |

To achieve a methane concentration of 2.0% in the combined feed stream (2), 200 lbmol/hr of the methane recycle stream (22) was recycled. Increasing the methane composition from 0.4% to 2.0% increases the dew point temperature of the feed syngas stream from 103.8° K to 107.9° K as shown in Table 2. Although this difference in dew point temperature might initially appear to be insignificant, it leads to an increase in the CO₂ concentration at which sublimation can initiate by more than three times, from 26 ppb to 84 ppb. This means that the allowable CO₂ concentration (no freezing) in the second case can be three times higher than in the first case. This is a significant advantage in instances when the dryer performance does not meet its design specifications, typically about 50 ppb of CO₂ for feeds that are expected to contain about 2% methane.

Table 2 depicts the impact of methane addition to the cold box feed for the feed composition and pressure used in the example of the present invention is provided. The recycle flow rate can be set based on what was deemed sufficient to provide adequate protection for CO₂ in the feed. If less protection were required, possibly because there was more methane in the feed, the methane recycle flow could be reduced. If more methane is desired, the flow rate can be increased. As methane is added to the feed, the methane concentration obviously increases, and the dew point of the feed mixture also increases. The increase in dew point ensures that the feed will begin to condense at a higher temperature. The increase in condensation temperature corresponds to an increasing CO₂ concentration that would begin to freeze at that temperature. Because CO₂ is soluble in liquid methane, it will dissolve in the liquid before it freezes, but there must be liquid present to act as a solvent. The last column indicates the maximum possible CO₂ concentration for which freezing can be prevented for the corresponding dew point temperature. The impact of even a small amount of methane addition can significantly increase the allowable CO₂ concentration.

TABLE 2
Effect of Methane Addition on Allowable
CO₂ Concentration at 380.7 PSIA

| Methane | | |
|---|---|---|
| Concentration | Dew | Maximum CO₂ |
| After Addition | Point | Concentration |
| % | K | ppb |
| 0.44 | 103.79 | 26.0 |
| 0.60 | 104.25 | 29.8 |
| 0.76 | 104.70 | 34.0 |
| 0.93 | 105.15 | 38.8 |
| 1.09 | 105.60 | 44.2 |
| 1.25 | 106.03 | 50.0 |
| 1.42 | 106.46 | 56.4 |
| 1.58 | 106.88 | 63.5 |
| 1.74 | 107.30 | 71.4 |
| 1.90 | 107.70 | 79.8 |
| 2.06 | 108.10 | 89.1 |
| 2.22 | 108.49 | 99.1 |
| 2.38 | 108.88 | 110.2 |
| 2.54 | 109.25 | 121.7 |
| 2.69 | 109.63 | 134.4 |
| 2.85 | 109.99 | 147.9 |

While the invention has been described in detail with reference to specific embodiments thereof, it will become apparent to one skilled in the art that various changes and modifications can be made, and equivalents employed, without departing from the scope of the appended claims.

What is claimed is:

1. A method for reducing carbon dioxide freezing in a partial condensation carbon monoxide cold box that separates a combined cold box syngas feed stream, comprising:
cooling and partially condensing the combined cold box syngas feed stream in a process heat exchanger to produce a cooled and partially condensed syngas feed stream;
separating the cooled and partially condensed syngas feed stream into a hydrogen rich vapor stream and a carbon monoxide rich liquid stream in a single-stage high-pressure separator;
routing the carbon monoxide rich liquid stream to a downstream separation train to separate and form at least a CO-rich stream, a methane-rich liquid stream, and a flash gas vapor stream;
wherein a methane-rich stream is added to the syngas feed upstream of a CO₂ freeze zone in the process heat exchanger to increase the concentration of methane in the mixture thereby reducing carbon dioxide freezing in the partial condensation carbon monoxide cold box.

2. The method of claim 1 in which a methane-rich liquid stream is vaporized in the process heat exchanger to form a methane-rich gas stream.

3. The method of claim 2 in which at least a portion of the methane-rich gas stream is introduced into the combined cold box syngas feed before it enters the freeze zone in the process heat exchanger.

4. The method of claim 1, wherein the dew point temperature of the syngas feed is raised to about 103-113° K in the combined cold box feed stream.

5. The method of claim 1, wherein the methane-rich recycle stream contains 10-98% methane by volume.

6. The method of claim 1, wherein addition of a methane-rich stream increases the methane content of the combined cold box syngas feed by at least 0.3 percentage points on a volume basis.

7. The method of claim 1, further comprising: routing the syngas feed stream to a dryer upstream of the cold box to remove the bulk of the carbon dioxide and water.

8. The method of claim 1, wherein the syngas feed is provided by a syngas generator selected from the group consisting of steam methane reformers, partial oxidation reactors, autothermal reformers, and steam methane reformers followed by secondary reformers.

9. The method of claim 3, further comprising: routing the hydrogen rich vapor stream to a pressure swing adsorption unit for further purification, wherein the tail gas is mixed with the methane-rich recycle stream and the syngas feed.

10. The method of claim 3, wherein the flash gas vapor stream is mixed with the methane-rich recycle stream and the syngas feed.

11. The method of claim 1, wherein a methane-rich liquid recycle portion is split from the methane-rich liquid and fed directly into the process heat exchanger upstream of the CO₂ freeze zone.

12. The method of claim 11, wherein the dew point temperature of the combined syngas feed passing through the CO₂ freeze zone is raised to about 103-113° K.

13. The method of claim 11, wherein addition of a methane-rich gas stream increases the methane content of the combined cold box syngas feed by at least 0.3 percentage points on a volume basis.

14. The method of claim 11, further comprising: routing the syngas feed stream to a dryer upstream of the cold box to remove the bulk of the carbon dioxide and water.

15. The method of claim 11, wherein the syngas feed is provided by a syngas generator selected from the group consisting of steam methane reformers, partial oxidation reactors, autothermal reformers, and steam methane reformers followed by secondary reformers.

16. The method of claim 1, wherein a syngas feed is generated from a hydrocarbon feed by a syngas generator selected from the group consisting of steam methane reformers, partial oxidation reactors, autothermal reformers, and steam methane reformers followed by secondary reformers; and a portion of the hydrocarbon feed from upstream of the syngas generator is split to form a methane-rich bypass stream and added to the syngas feed upstream of the cold box.

17. The method of claim 16, wherein a pre-reformer is disposed upstream of the syngas generator and the methane-rich bypass stream is a product of the pre-reformer.

18. The method of claim 16, wherein the hydrocarbon feed is pre-treated in a desulfurizer prior to splitting the methane-rich bypass stream.

19. The method of claim 16, wherein a CO₂ removal system removes carbon dioxide from the syngas formed by the syngas generator and forms a carbon dioxide depleted syngas.

20. The method of claim 19, wherein the carbon dioxide depleted syngas is routed to a separator to further remove water prior to routing the syngas to a dryer for the substantial removal of all H₂O and CO₂ prior to feeding the syngas stream to a partial condensation cold box.
